(19) United States
(12) Patent Application Publication
(10) Pub. No.: US 2007/0294835 A1
(43) Pub. Date: Dec. 27, 2007

(54) Process and Compositions for Wet Degreasing of Pelts, Skins, Hides, Leather Intermediate Products and Non-Finished Leather

(76) Inventors: Roberta Gamarino, Casale Monferrato (AL) (IT); Daniela Moresca, Carnate (MI) (IT); Licia Trimarco, Saronno (VA) (IT); Jon Mallon, South Yorkshire (GB)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/661,491

(22) PCT Filed: Aug. 26, 2005
(86) PCT No.: PCT/EP05/54200

§ 371 Date: Feb. 27, 2007

(30) Foreign Application Priority Data
Aug. 30, 2004 (EP) 04425640.2

(51) Int. Cl. C14C 1/08; C11D 1/825; C14C 5/00

(52) U.S. Cl. 8/94.1 R; 568/679

(57) ABSTRACT

The invention relates to wet degreasing of pelts, skins, hides, leather intermediate products or non-finished leather, with emulsion degreasing agents (D) comprising a mixture (E) of ethoxylation and optionally propoxylation products of a mixture (A) of oxo-alcohols of formula
CₙH₍₂ₙ₊₁₎—CH₂OH (I), in which n is a number from 9 to 15,
and the alkyl radical CₙH₍₂ₙ₊₁₎— is linear,
wherein (A) comprises a mixture of positional isomers for at least one of the significances of n, and the proportion of primary linear component in (A) in which the alkyl radical CₙH₍₂ₙ₊₁₎— is a normal primary radical is in the range of 25 to 70% by weight of the mixture (A), and in (E) the average degree of ethoxylation is in the range of 5 to 12, and if the products (E) are also propoxylated the average degree of ethoxylation is superior to the average degree of propoxylation, in the presence of at least one further non-ionic emulsifier which is (F) at least one ethoxylation and optionally propoxylation product of (B) an aliphatic saturated at least twice branched alcohol or mixture, and emulsion degreasing compositions (D′) comprising mixtures (E) and products (F), and optionally one or more formulation additives (S).

In the production of tanned finished leather the quality of the final product depends to a high degree on the treatment of the hides, pelts or skins in the beamhouse, where substances and components present in the substrates and which are not desired for the later treatment are removed from the substrate. In this one particular aspect is the removal of grease. This can be done by means of solvents (by the so-called dry degreasing, usually with chlorinated organic solvents) or in the presence of water by emulsifying extraction of the grease from the substrate (by the so-called wet degreasing) in the presence or in the absence of solvents. Dry degreasing with solvents presents various drawbacks, such as the disposal or recovery or reclaiming of the used large amounts of solvents, and also the quality of the resulting degreased substrate, which by the use of solvents in dry degreasing may loose in part the typical leather handle, changing to a drier touch, and may sometimes even become brittle; dry degreasing of pelts is mostly not even feasible in practice due to the closing of the pores during degreasing. And similar considerations apply also for the dry degreasing of leather intermediates and non-finished leather. Wet degreasing by emulsifying extraction of the grease is the preferred way of working in practice, although the degreasing yield usually is lower than by dry degreasing, and is used in the beamhouse or also at a later stage of leather production in the wet end, i.e. in tannery or in the post-tanning section of the wet end, e.g. from a leather intermediate or also from a non-finished leather.

A known category of degreasing agents for wet degreasing by emulsifying extraction of the grease—briefly “emulsion degreasing agents”—is based on non-ionic emulsifiers which are alkoxylated, mainly ethoxylated, alcohols.

A typical category of ethoxylated alcohols are ethoxylated alkylphenols, mainly ethoxylated nonyl phenols, which have heretofore been employed with preference due to their high and satisfactory degreasing efficiency. These may, however, present ecological and toxicological drawbacks, so that it is desirable to replace them.

As ethoxylated alcohols there have also been employed some ethoxylated oxo-alcohols, however, although ecologically and economically desirable, they did not reach the level of degreasing efficiency and quality of ethoxylated nonylphenols.

A further category of ethoxylated alcohols is described in WO 03/010340 A1, where it has been proposed to use certain alkoxylation products, in particular ethoxylation products of certain aliphatic saturated alcohols presenting a particular median branching of the main chain, and which are synthesizable by Grignard synthesis or aldol condensation. From the comparative tests described in this document (e.g. in Table 1 and in the comparative examples) and also from the content of the specification results that these ethoxylated alcohols provide a degreasing effect that is similar to the one of correspondingly ethoxylated nonylphenols and is highly improved over the one of conventional correspondingly ethoxylated oxo-alcohols.

It has now surprisingly been found that with the below defined emulsion degreasing agents, which are based on particular ethoxylated and optionally propoxylated oxo-alcohols, there can be achieved in wet degreasing of pelts, skins, hides, leather intermediate products or non-finished leather an outstanding and highly satisfactory degreasing of the substrates.

The invention relates to the defined process for wet degreasing of pelts, skins, hides, leather intermediate products or non-finished leather, to certain degreasing agents and compositions and to their production.

The invention thus firstly provides a process for wet degreasing of pelts, skins, hides, leather intermediate products or non-finished leather, by treatment with an emulsion degreasing agent in the presence of water, characterised in that an emulsion degreasing agent (D) comprising
a mixture (E) of ethoxylation products or ethoxylation and propoxylation products of a mixture (A) of oxo-alcohols of formula
   CₙH₍₂ₙ₊₁₎—CH₂OH (I),
   in which
   n is a number from 9 to 15,
and the alkyl radical CₙH₍₂ₙ₊₁₎— is linear,
wherein (A) comprises a mixture of positional isomers for at least one of the significances of n, and the proportion of primary linear component in (A) in which the alkyl radical
   CₙH₍₂ₙ₊₁₎— is a normal primary radical is in the range of 25 to 70% by weight of the mixture (A),
   in (E) the average degree of ethoxylation is in the range of 5 to 12, and if the products (E) are also propoxylated the average degree of ethoxylation is superior to the average degree of propoxylation,
      is employed as a degreasing agent in the presence of at least one further non-ionic emulsifier which is
   (F) at least one ethoxylation product or ethoxylation and propoxylation product of
      (B) an aliphatic saturated at least twice branched alcohol or mixture.

As oxo-alcohol mixtures (A) there may be employed mixtures of positional isomers as are obtainable by conventional oxo-synthesis and reduction, from a corresponding mixture of linear alkenes CₙH₂ₙ. In particular the mixtures (A) comprise for at least one n a mixture of positional isomers, in each of which the methylol group is linked to one of each of the positions 1 to n/2 if n is an even number (i.e. 10, 12 or 14), or to one of each of the positions 1 to (n+1)/2 if n is an odd number (i.e. 9, 11, 13 or 15).

They may be represented by the following general formula 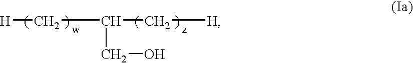
wherein
w is a number in the range of n/2 to n−1 if n is 10, 12 or 14,
   or is a number in the range of (n−1)/2 to n−1if n is 9, 11, 13 or 15,
and z=n−w−1,
   in which, referred to a mixture (Aₙ) of alcohols for one value of n as 100%, the proportion of component (Aₙₐ) in which w=n−1is in the range of 25 to 70% by weight of the mixture and the other components in which w<n−1 are the remaining 75 to 30% by weight of the mixture in statistical distribution.

Thus, where n is 9 the corresponding mixture (A₉) comprises the positional isomers 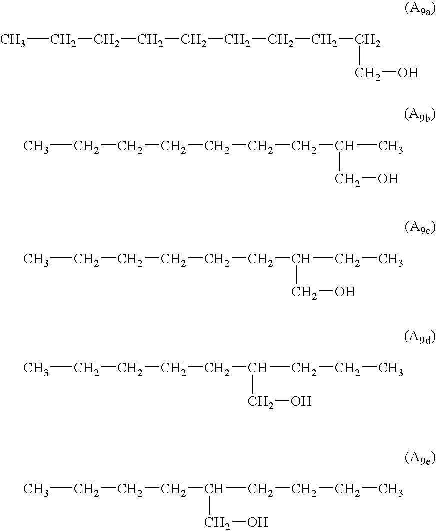
in which the proportion of (A₉ₐ) is in the range of 25 to 70% by weight of the mixture and the proportion of the other components (A_{9b}), (A_{9c}), (A_{9d}) and (A₉ₑ) is the remaining 75 to 30% by weight in statistical distribution.

Where n is 10 the corresponding mixture (A₁₀) comprises the positional isomers 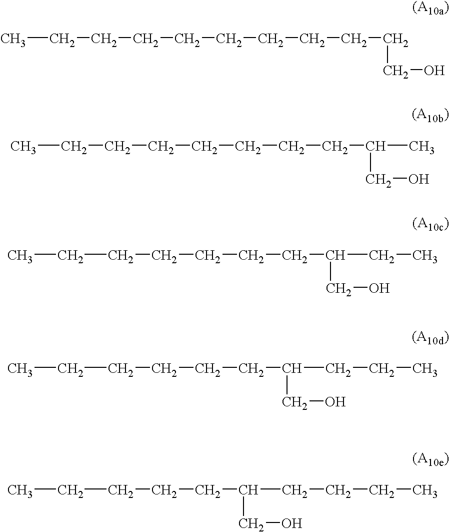
in which the proportion of (A₁₀ₐ) is in the range of 25 to 70% by weight of the mixture and the proportion of the other components (A_{10b}), (A_{10c}), (A_{10d}) and (A₁₀ₑ) is the remaining 75 to 30% by weight in statistical distribution.

Where n is 11 the corresponding mixture (A₁₁) comprises the positional isomers 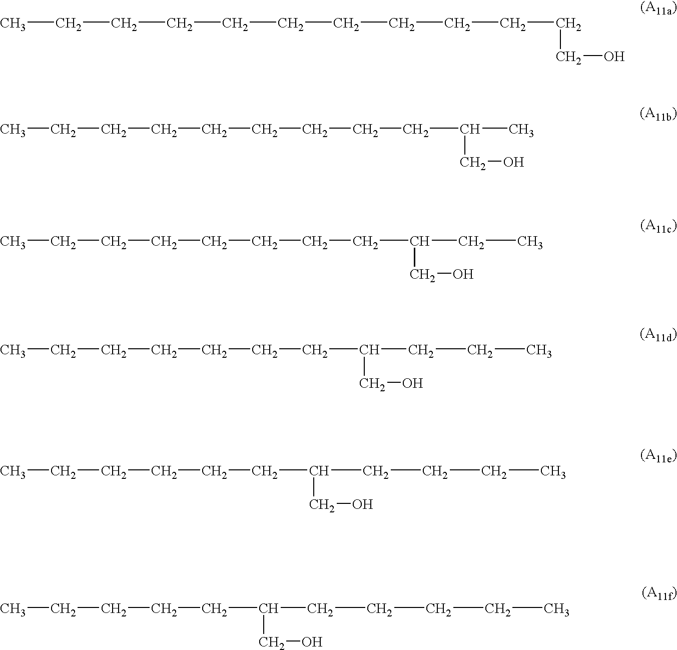
in which the proportion of (A₁₁ₐ) is in the range of 25 to 70% by weight of the mixture and the proportion of the other components (A_{11b}), (A_{11c}), (A_{11d}), (A₁₁ₑ) and (A_{11f}) is the remaining 75 to 30% by weight in statistical distribution. And so on for (A₁₂), (A₁₃), (A₁₄) and (A₁₅).

Thus, analogously, for
(A₁₂), in which n=12, (A₁₂ₐ) is the primary linear component and (A_{12b}) to (A_{12f}) are the other positional isomers,
(A₁₃), in which n=13, (A₁₃ₐa) is the primary linear component and (A_{13b}) to (A_{13g}) are the other positional isomers,
(A₁₄), in which n=14, (A₁₄ₐ) is the primary linear component and (A_{14b}) to (A_{14g}) are the other positional isomers
and (A₁₅), in which n=15, (A₁₅ₐ) is the primary linear component and (A_{15b}) to (A₁₅ₕ) are the other positional isomers.

The proportion of primary linear component wherein the alkyl radical CₙH₍₂ₙ₊₁)— is a normal primary radical in (A), or of (Aₙₐ) in (Aₙ), preferably is in the range of 30 to 60% by weight of the mixture, and the proportion of the branched positional isomers is the remaining 70 to 40% by weight of the mixture, in statistical distribution. More preferably the proportion of primary linear component (Aₙₐ), wherein the alkyl radical CₙH₍₂ₙ₊₁₎— is a normal primary radical, in (Aₙ) preferably is in the range of 35 to 55% by weight of the mixture, and the proportion of the branched positional isomers is the remaining 65 to 45% by weight of the mixture, in statistical distribution. n preferably is a number in the range of 10 to 15, more preferably in the range of 10 to 14.

According to one aspect of the invention, as (A) there is employed only one species (Aₙ), wherein n has only one value, i.e. (A₉) or (A₁₀) or (A₁₁) or (A₁₂) or (A₁₃) or (A₁₄) or (A₁₅). In this case (A) or (Aₙ) preferably is (A₁₀).

According to another aspect of the invention, as (A) there is employed a mixture of two or more species (Aₙ), wherein n has correspondingly two or more values, i.e. a mixture of two or more of (A₉), (A₁₀), (A₁₁), (A₁₂), (A₁₃), (A₁₄) and (A₁₅), preferably of two or more of (A₁₀), (A₁₁), (A₁₂), (A₁₃) and (A₁₄), more preferably a mixture comprising the range of (A₁₁) to (A₁₄). Representative mixtures are e.g.
(A₁₁)+(A₁₂)
or (A₁₃)+(A₁₄)
or (A₁₁)+(A₁₂)+(A₁₃)+(A₁₄)
or a mixture of one or more thereof with (A₁₀).

(A) or (Aₙ) may be used in pure form, or advantageously in a technical grade which may contain some impurities and/or by-products, e.g. up to 8% by weight, preferably≦5% by weight of by-products from oxo-synthesis and/or reduction, e.g. hydrocarbons, carbonyl compounds and/or components—mainly alcohols—of higher or lower molecular weight, as usually present in technical grade oxo-alcohols. Preferably the by-products do not comprise any carbonyl compounds or only traces (<0.1% by weight), while any hydrocarbons may be present only in traces (<0.1% by weight). The above mixture components (A₉), (A₁₀), (A₁₁), (A₁₂), (A₁₃), (A₁₄) or (A₁₅), in particular each of (A₁₀), (A₁₁), (A₁₂), (A₁₃) and (A₁₄), when present in the above mentioned mixtures, are preferably present in a proportion higher than an impurity, in particular>5% by weight, more preferably>8% by weight.

The ethoxylated products or ethoxylated and propoxylated products (E) are known or may be produced in a manner conventional per se by addition reaction of ethylene oxide or of ethylene oxide and propylene oxide to the mixture (A).

As ethoxylation there is meant herein the addition reaction of ethylene. oxide (also known as oxyethylation). As propoxylation there is meant herein the addition reaction of propylene oxide (also known as oxypropylation).

The addition reaction may be carried out under reaction conditions known per se, preferably in the presence of an alkali metal hydroxide, e.g. sodium hydroxide or potassium hydroxide, with heating, e.g. at a temperature in the range of 90 to 240° C., preferably 130 to 220° C. in a closed vessel, in the presence of an inert gas, e.g. nitrogen. If propylene oxide is also reacted, it is preferably reacted first, followed by the reaction of ethylene oxide. Propylene oxide, if used, is employed in a minor proportion, preferably in this case there being added 1 to 2 moles of propylene oxide per mole of oxo-alcohol mixture (A); more preferably no propylene oxide is added, but the mixture (A) is reacted only with ethylene oxide. The molar proportion of ethylene oxide referred to oxo-alcohol mixture (A) is in the range of 5 to 12, preferably 6 to 10.

The mixtures (E), which are ethoxylation products or ethoxylation and propoxylation products of oxo-alcohols (A), may be represented by the following average formula 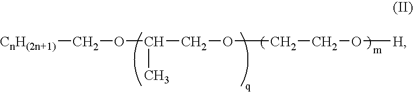
in which
m is a number from 5 to 12,
and q<m.

In formula (II) q preferably is 0, 1 or 2, more preferably 0.

The preferred mixtures (E) are (E′) i.e. ethoxylation products of oxo-alcohols (A) and may be represented by the following average formula
CₙH₍₂ₙ₊₁₎—CH₂O—(CH₂CH₂—O)ₘ—H (IIa),
in which
m is a number from 5 to 12.

Preferably m is a number in the range of 6 to 10.

Preferably (E) or (E′) are ethoxylation products of alcohols (A) in which n is in the range of 10 to 15 or, more preferably, 10 to 14.

The HLB (=hydrophilic-lipophilic balance) of the mixture (E) preferably is in the range of 11 to 15, more preferably 11.5 to 13.5, most preferably<13, in particular between 12 and 13. The HLB of ethoxylates may be calculated by the known approximate formula

$$HLB = \frac{e}{5}$$

in which e is the weight percent of oxyethylene units present in the product.

In the reaction of ethylene oxide, and optionally propylene oxide, with the oxo-alcohol mixture (A) or (Aₙ) the single components of the oxo-alcohol mixture (A) or (Aₙ) may have a different reactivity, depending e.g. on the sterical configuration of the single components, which may lead to a varying degree of alkoxylation (ethoxylation and any propoxylation) in each component of the mixture, and in the single ethoxylated components the degree of ethoxylation may range broadly, e.g. in the scope of 0 to 3 m, mainly in the scope of 0.5 m to 2 m. The above stated values of propoxylation and ethoxylation are average values of the reacted mixtures. An analogous consideration applies to the HLB.

According to a particular feature of the invention it is possible to mix different alkoxylation products (E) or preferably (E′) with each other, e.g. an ethoxylation product of one of the above mentioned mixtures of two or more oxo-alcohol mixture species in the range of (A₁₁) to (A₁₄) may be mixed with an ethoxylation product of oxo-alcohol mixture species (A₁₀). In such mixtures each alkoxylated species is expediently present in a proportion>5%, preferably>8% by weight of the total mixture (E) or preferably (E′) present in (D).

For degreasing, (E) or preferably (E′) is combined with at least one further non-ionic emulsifier which is (F) at least one ethoxylation product or ethoxylation and propoxylation product of (B) an aliphatic saturated at least twice branched alcohol or mixture. Preferably (B) is (B₀) an aliphatic saturated at least twice branched primary alcohol, or mixture. The branches may be at different carbon atoms or two branches may even be at one same carbon. More preferably (B) or (B₀) is an oxo-alcohol or mixture, in particular (B₁) an oxo-alcohol with at least two branchings, especially with more than 2 branchings on average. Accordingly (F) preferably is (F₀) at least one ethoxylation product or ethoxylation and propoxylation product of (B₀), more preferably (F₁) at least one ethoxylation product or ethoxylation and propoxylation product of (B₁).

The lipophilic hydrocarbon radical in (B) may e.g. contain 8 to 22 carbon atoms, preferably 9 to 18, more preferably 10 to 17 carbon atoms, and is preferably branched at at least three different carbon atoms. (B) or respectively (B₀) or (B₁) preferably is (B₂) an oxo-alcohol of the average formula
CₚH₍₂ₚ₊₁₎—CH₂OH (III),
in which
p is a number from 9 to 16
and the alkyl radical CₚH₍₂ₚ₊₁₎— is branched at at least three different carbon atoms, or a mixture of two or more thereof.

As branched oxo-alcohols (B₁) or (B₂) there may be employed single compounds or mixtures, mostly mixtures of positional isomers or/and homologues, as are obtainable by conventional oxosynthesis and reduction from corresponding branched alkenes CₚH₂ₚ or mixtures thereof. Preferably CₚH₂ₚ are branched alkenes as obtainable by oligomerisation of propene or/and butene, e.g. by trimerisation or tetramerisation of butene or trimerisation to pentamerisation of propene, or any combinations thereof. More preferably CₚH₂ₚ is a trimerisation product of butene. Depending on the starting alkene monomers and oligomerisation conditions, the branched alkenes CₚH₂ₚ may be a single compound or a mixture, mostly a mixture. Analogously as mentioned above for (A), also (B) may be used in pure form, or advantageously in a technical grade which may contain some impurities and/or by-products, e.g. up to 8% by weight, preferably≦5% by weight of by-products, so that e.g. a technical grade oxo-alcohol (B₁) or (B₂) with three branchings may in practice have an average branching degree ranging from 2.8 to 3.2.

Accordingly (F) or respectively (F₀) or (F₁) preferably is (F₂), i.e. an ethoxylation product or ethoxylation and propoxylation product of (B₂).

The degree of ethoxylation and any propoxylation is chosen advantageously in such a range that the HLB of (F) is in the hydrophilic range, preferably above 10, more preferably between 11 and 15.

In (F₁) and (F₂) the average degree of ethoxylation preferably is in the range of 5 to 12, and if the product (F₁) or (F₂) is also propoxylated the average degree of ethoxylation is superior to the average degree of propoxylation.

The preferred components (F₂), which are ethoxylation products or ethoxylation and propoxylation products of (B₂), may be represented by the following average formula 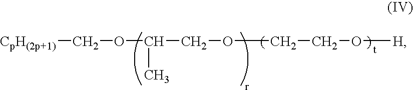
in which
t is a number from 5 to 12,
and r<t.

In formula (IV) r preferably is 0, 1 or 2, more preferably 0. t preferably is 6 to 10.

As non-ionic emulsifiers (F), there may be employed known products or products that may be synthesised in a manner known per se. Analogously as described above for the mixtures (E), the products (F), or respectively (F₀), (F₁) or (F₂), may be produced by methods conventional per se, suitably by addition reaction of ethylene oxide and optionally propylene oxide to the aliphatic saturated branched alcohols (B) or (B₀) or in particular branched oxo-alcohols (B₁) or (B₂). The addition reaction may be carried out under reaction conditions known per se, preferably in the presence of an alkali metal hydroxide, e.g. sodium hydroxide or potassium hydroxide, with heating, e.g. at a temperature in the range of 90 to 240° C., preferably 130 to 220° C. in a closed vessel, in the presence of an inert gas, e.g. nitrogen. If propylene oxide is also reacted, it is preferably reacted first, followed by the reaction of ethylene oxide. Propylene oxide, if used, is expediently employed in a minor proportion, preferably in this case there being added 1 to 2 moles of propylene oxide per mole of alcohol (B) or (B₀) or oxo-alcohols (B₁) or (B₂); more preferably no propylene oxide is added, but (B) is reacted only with ethylene oxide. The molar proportion of ethylene oxide referred to oxo-alcohols (B₁) or (B₂) preferably is in the range of 6 to 10 moles of ethylene oxide per mole of oxo-alcohol (B₁) or (B₂).

Preferred components (F₂) correspond to the average formula
CₚH₍₂ₚ₊₁₎—CH₂O—(CH₂CH₂—O)ₜ—H (IVa).

The HLB of the component (F₂) preferably is in the range of 11 to 15, more preferably 11.5 to 13.5, e.g. below 13, in particular between 12 and 13.

For the degreasing of the invention, component (F) is advantageously combined with component (E) in a composition (D′). The invention thus further provides an emulsion degreasing agent which is a composition (D′) comprising degreasing active components (E), preferably (E′), and (F). Preferred compositions (D′) are (D₀), i.e. those in which (F) is (F₀), more preferred compositions (D′) are (D₁) i.e. those in which (F) is (F₁), most preferred compositions (D′) being (D₂) i.e. those in which (F) is (F₂).

Emulsion degreasing composition (D′) may further comprise one or more formulation additives (S) e.g. for adjusting the physical aspect of the composition and/or its use properties. (S) may in particular comprise one or more solvents and/or solubilisers and/or a defoamer and/or one or more anionic surfactants. Preferably (S) is selected from the group consisting of
(S₁) water,
(S₂) an organic solvent or mixture of organic solvents and/or a solubiliser or mixture of solubilisers, miscible with or soluble in (E) and (F) or in which (E) and (F) are soluble,
(S₃) a defoamer
and/or (S₄) at least one anionic surfactant.

That the products (S₂) and (E) or (F) are miscible or soluble means that (S₂) in combination with (E) and/or (F) can give a clear solution in the employed proportion.

Advantageously (S₂) is
an organic solvent miscible with water, which is aliphatic and contains at least one oxygen and no other heteroatoms, or a mixture of two or more such solvents.

Preferably (S₂) is selected from the group consisting of aliphatic mono- or oligofunctional alcohols and mono- or di-(C₁₋₄-alkyl)-ethers thereof. (S₂) may include water-miscible, saturated aliphatic solvents of ether and/or alcohol character, e.g. also as described below under (H). As (S₂) there may in particular be employed a C₃₋₄-alkanol, a diol which is a C₂₋₄-alkylene glycol or a higher diol e.g. with 6 carbon atoms mainly 2-methyl-2,4-pentanediol (hexylene glycol), dipropylene glycol or a di-, tri- or tetraethylene glycol, and mono- or di-(C₁₋₄-alkyl)-ethers thereof, or glycerol. Particularly preferred solvents or solubilisers (S₂) include e.g.: isopropanol, mono- or dipropylene glycol, mono-, di-, tri- or tetraethylene glycol, hexylene glycol, mono- or dipropylene glycol monomethylether, ethylene glycol monobutylether and methyl, ethyl, isopropyl or butyl mono- or diethers of di-, tri- or tetraethylene glycol.

As solvents/solubilisers in (S) there may be employed water (S₁) alone, solvent or solubiliser (S₂) alone or a mixture of water (S₁) and solvent or solubiliser (S₂).

As defoamers (S₃) there may be employed known products in the commercially available forms, e.g. silicones, silica, paraffins, paraffin oil, mineral oil or trialkylphosphates (e.g. triisopropyl-phosphate or tributylphosphate), in an efficient concentration, e.g. below 0.2% by weight, preferably below 0.1% by weight, referred to (E)+(F). Mostly a defoamer (S₃) is not necessary and is not added in (D) or (D′).

As anionic surfactants (S₄) there may be employed any conventional anionic surfactants in particular with emulsifier character, in particular as described below under (G), and which preferably contain a sulpho group. Preferably as (S₄) there are employed araliphatic or more preferably aliphatic sulphates, which may contain a heteroatomic bridge in the aliphatic chain (e.g. an ester, amide or preferably ether bridge) and which contain a lipophilic hydrocarbon radical e.g. with 7 to 24 carbon atoms, more preferably sulphuric acid monoesters of fatty alcohols or of ethoxylated (e.g. mono- to oligo-ethoxylated) fatty alcohols with e.g. 12 to 24 carbon atoms in the fatty hydrocarbon radical. Among these the sulphuric acid esters of ethoxylated fatty alcohols are preferred. The anionic surfactants (S₄) are preferably in the form of alkali metal salts, more preferably sodium or potassium salts.

The degreasing agents (D′) of the invention thus are compositions—in particular emulsion degreasing compositions—comprising a mixture of (E) and (F) or of (E), (F) and (S). According to a preferred feature of the invention, compositions (D′) do not contain other components than (E), (F) and—if present—(S), but consist essentially of (E) and (F) or of (E), (F) and (S). If a formulation adjuvant (S) is present in (D′), it is preferably present in a minor proportion, i.e. <50% by weight of (D′). If water (S₁) is present in (D′), it is preferably present in a proportion below 50% by weight of (D′), preferably in the range of 2 to 40% by weight of (D′), e.g. 3 to 20% by weight. According to one preferred feature of the invention the water content is below 20% by weight of (D′), e.g. even below 10% by weight of (D′), especially if no (S₂) and no (S₄) is present. If an organic solvent or solubiliser (S₂) is present in (D′), it is preferably present in a proportion<30% by weight of (D′), its proportion more preferably being in the range of 1 to 20% by weight of (D′). Most preferably the (S₂)-content is below 10% by weight of (D′). If a mixture of water (S₁) and organic solvent or solubiliser (S₂) is present in (D′), the weight ratio of (S₁)/(S₂) is e.g. in the range of 1/9 to 9/1, preferably 4/6 to 8/2, and it is preferably present in a proportion below 40% by weight of (D′), preferably in the range of 4 to 30% by weight of (D′), most preferably below 25% by weight.

If the compositions (D′) contain a solvent or solubiliser (S₂), preferably no anionic surfactant (S₄) is present, and if they contain (S₄) preferably no (S₂) is present.

If an anionic surfactant (S₄) is present in (D′) it is preferably present in a proportion that does not exceed the amount of anionic surfactant to be present in total in the degreasing bath. Very small proportions of anionic surfactant (S₄), e.g. below 10% by weight referred to (E)+(F), preferably below 5% by weight referred to (E)+(F), are sufficient and particularly suitable in (D′). Preferably (S₄)—if employed—is present in a concentration in the range of 0.2 to 10, preferably 0.5 to 5% referred to (E)+(F). If an anionic surfactant (S₄) is present in (D′), (D′) preferably comprises also water (S₁).

The (F)-content in (D′)—and more particularly the (F₀)-content in (D₀), or the (F₁)-content in (D₁), or the (F₂)-content in (D₂),—preferably does not exceed the (E)-content. The (E)-content in (D′) is e.g. in the range of 30 to 90% by weight, preferably 40 to 80% by weight, more preferably 45 to 70% by weight. In (D′) the weight ratio of (E) to (F)—and more particularly the weight ratio of (E) to (F₀) in (D₀), or the weight ratio of (E) to (F₁) in (D₁), or the weight ratio of (E) to (F₂) in (D₂),—preferably is in the range of 100/5 to 100/100, e.g. 100/10 to 100/80, more preferably in the range of 100/12 to 100/60.

According to a particular feature of the invention, components (E) and (F) and—if present—also (S), in particular (S₂), are chosen in such a kind and ratio that the cloud point T_{C} of the mixture (E)+(F) or composition (D′) is close to the temperature of use for degreasing T_{D}. E.g. the cloud point T_{C} expressed in ° C. may be within the range of T_{D}, expressed in ° C., ±7° C., e.g. within the range of T_{D}±5° C. According to another particular feature, the cloud point T_{C} of (D′) is well below TD, e.g. below 10° C., compositions (D′) with no cloud point being particularly preferred.

The compositions (D′) of the invention may be produced in a manner conventional per se, e.g. by mixing the components (E) and (F) and any (S), or they may be produced by alkoxylation of a corresponding mixture of (A) and (B)—in particular (A) and (B₀), or (A) and (B₁), or (A) and (B₂)—and, if (D′) is to comprise also (S), addition of (S).

The plain admixing of (E) with (F) and any (S) may be carried out e.g. at a temperature in the range of 15 to 50° C. The alkoxylation (ethoxylation and any propoxylation) of the mixture of (A) and (B) may be carried out under the same reaction conditions as mentioned above for the alkoxylation of the single components (A) or (B), and formulation additive (S) may then be added after completion of the alkoxylation reaction and cooling, e.g. to a temperature below 80° C., e.g. between 15 and 50° C.

The so produced compositions (D′) are ready for use. They, in particular the concentrated compositions, especially (D₂), with no water or only a minor proportion of water, are of satisfactory stability to storage and transportation even under condition of frost or heat (e.g. in the temperature range of −10° C. to +50° C.), and are pumpable. They are readily dilutable with water and may e.g. be directly metered into the treatment bath, in particular into the drum, for degreasing.

The degreasing of the invention is carried out in the presence of water, in particular of water containing dissolved sodium chloride, and may be carried out at any suitable stage of the wet end of leather and pelt production and processing, e.g. in the beamhouse, in tannery or/and in the post-tanning section of the wet end for the further processing of tanned leather and pelts, mainly for the production of dyed and/or finished, leather or pelts.

The invention thus further provides a process for wet degreasing of pelts, skins, hides, leather intermediate products or non-finished leather or pelts, characterised in that a composition (D′) as defined above is employed as a degreasing agent. In particular the invention provides a process for the production of leather, pelts or furskins, comprising in their production at least a wet degreasing treatment, a tannage and a dyeing or finishing treatment, wherein degreasing is carried out with (D′).

As a substrate to be degreased according to the invention there may be employed any hides, skins or pelts as conventionally processed in the beamhouse, and which contain their own natural grease within the collagenous fibre texture in various proportions. There may e.g. be mentioned pelts, hides or skins from sheep, goat, swine, cattle and other animals (e.g. horse, colt, reptiles—e.g. snake, lizards, water reptiles—, doe, deer, ostrich, poultry, dromedary, camel and camel-like animals—e.g. lama or alpaca—), and woolled skins (mainly from sheep or goat) and furskins. The degreasing agent of the invention may also be employed for degreasing already tanned and not yet finished leather or pelts. It is suitable in particular for the degreasing of hides or skins with a typically high grease content such as sheep or swine, mainly in the beamhouse and in tannery, e.g. after pickling.

In the beamhouse the substrates may be degreased according to the invention in those processing stages as conventional per se for degreasing, i.e. after liming, after bating, and/or during or after pickling.

Degreasing according to the invention may also be applied to leather intermediate products or non-finished leather. Thus if the substrate has already been tanned at least in part, degreasing may be carried out e.g. before dyeing, mostly in order to improve dyeability, or before finishing, e.g. in order to reduce the fat content as may have been introduced after tanning by fatliquoring, in order to prepare the substrate for a particular finish e.g. a lacquer (laminate) finish.

In degreasing, the degreasing agent (D) or (D′) may be used alone or preferably in the presence of one or more further assistants. To the degreasing bath there may e.g. be added one or more anionic surfactants (G) and/or a water miscible solvent (H).

As surfactants (G) of anionic character there may be employed any conventional surfactants as usually employed in degreasing, preferably those containing a sulpho group, e.g. aliphatic or araliphatic sulphates (G₁) or sulphonates (G₂), which may contain a heteroatomic bridge in the aliphatic chain (e.g. an ester, ether or preferably amide, bridge, an ether bridge being with particular preference part of a glycol ether chain) and which contain a lipophilic hydrocarbon radical e.g. with 7 to 24 carbon atoms. They are preferably in the form of alkali metal salts, more preferably sodium or potassium salts.

Suitable sulphates (G₁) are e.g.:
(G₁′) sulphuric acid monoesters of fatty alcohols or of ethoxylated (e.g. mono- to oligo-ethoxylated) fatty alcohols with e.g. 12 to 24 carbon atoms in the fatty hydrocarbon radical,
(G₁″) sulphuric acid esters of fatty acid monoglycerides with e.g. 12 to 24 carbon atoms in the fatty acid radical,
(G₁′″) products of sulphation of unsaturated fatty acids or unsaturated oils (fatty acid triglycerides) with e.g. 18 to 22 carbon atoms in the unsaturated fatty acid radical or of ricinoleic acid or castor oil.

Suitable sulphonates (G₂) are e.g.
(G₂′) fatty alkyl sulphonates and isethionates, with e.g. 12 to 24 carbon atoms in the fatty hydrocarbon radical, petroleum sulphonate (mainly secondary sulphonates with e.g. 10 to 15, usually 12 to 13, carbon atoms in the aliphatic chain),
(G₂″) fatty acid taurides and N-methyltaurides with e.g. 12 to 24 carbon atoms in the fatty acid radical,
(G₂′″) products of sulphitation of unsaturated fatty acids or unsaturated oils (fatty acid triglycerides) with e.g. 16 to 24 carbon atoms in the unsaturated fatty acid radical,
(G₂″″) mono- and di-alkyl-benzene sulphonates with e.g. a total of 1 to 12 carbon atoms in the alkyl substitution, e.g. with 4 to 12 carbon atoms in the alkyl chain, or short chain alkyl-benzene sulphonates with 1 to 3 carbon atoms in the alkyl radical and in the total alkyl substitution.

As mono- to oligo-ethoxylated in (G₁′) there is meant the addition product of 1 to 10 moles of ethylene oxide to one mole of fatty alcohol. As examples of (G₁) there may be mentioned in particular lauryl sulphate, stearyl sulphate, and the sulphates of the addition product of 1 to 6 moles of ethylene oxide to one mole of lauryl or stearyl alcohol. As examples of (G₂) there may be mentioned in particular toluene-, xylene- or cumene-sulphonic acids, and fatty acid taurides or N-methyl taurides with on average 16 to 20 carbon atoms in the fatty acid radical. They are preferably in the form of potassium salts or more preferably sodium salts.

The solvents (H) are water-miscible, organic, preferably aliphatic solvents containing at least two linked oxygen atoms per molecule in the form of alcoholic hydroxy groups and/or ether bridges, and are in particular exempt of other heteroatoms than oxygen. There may in particular be mentioned saturated aliphatic compounds of ether and/or alcohol character, mainly mono-, di-, tri- and/or tetra-alkylene glycols and their mono- or di-(C₁₋₄-alkyl) ethers, preferably with≧4 carbon atoms in the molecule, more preferably with≧6 carbon atoms, e.g. butane-2,3- or -1,4-diol, dipropylene glycol, monomethyl ether of mono- or dipropylene glycol, and methyl-, ethyl-, isopropyl- or butyl-ethers of mono-, di-, or triethylene glycol, among which the monoalkylethers are preferred, especially diethylene glycol mono-butyl ether.

Wet degreasing with (D) or (D′) according to the invention may be carried out analogously to methods known per se, expediently in a treatment drum our on a beam, in an aqueous bath e.g. in the range of 50 to 250%, preferably 80 to 200%, more preferably 100 to 180% by weight referred to the wet weight of the substrate. The temperature T_{D} for degreasing advantageously is in the range of 15 to 40° C., preferably 18 to 30° C., usually e.g. at 20 to 25° C. The pH may be as desired and as corresponds to the treatment stage at which degreasing is carried out. Components (E) and (F) are judiciously employed in an efficient amount for achieving the desired degreasing. The concentration of (E) and (F) or of degreasing agent (D) or (D′) expressed as weight-% of dry substance (E)+(F) referred to the substrate may vary broadly, mainly depending on the grease content of the substrate and the desired degreasing effect and further also on the other treatment parameters and treatment stage. A suitable range for the concentration of degreasing agent (D) or (D′) referred to the wet weight of the substrate is in the range of 0.5 to 12%, preferably 1 to 6% by weight of dry substance (E)+(F) (or respectively 1 to 24%, preferably 2 to 12% by weight thereof referred to the dry weight of the substrate).

Degreasing with (E) and (F), in particular with (D) or (D′) may be carried out in one or more stages—in particular those mentioned above—, and in each stage it may be carried out in one or more, preferably two, steps. If it is carried out in two steps, one step may be regarded as the main step for the extraction of the higher proportion of grease, while the second step may be regarded as a follow-up step for improving the degreasing effect and the substrate properties. If a solvent (H) is added in the degreasing bath, it is preferably added in the main degreasing bath, and its concentration may vary analogously as mentioned above for (D). Preferably the concentration of solvent (H) is inferior to the concentration of (E)+(F). The concentration of solvent (H) may e.g. range in the scope of 10 to 80%, preferably 20 to 60% by weight, of the concentration of (E)+(F), especially (E)+(F₂).

One or more of the above mentioned surfactants (G) may be added in the bath, as desired, for emulsifying the extracted grease and keeping it in emulsion, in order to avoid redeposition of the grease on the substrate and also in order to avoid any creaming and smearing on the inner parts of the apparatus or/and on the degreased goods. In the bath the concentration of surfactants (G) may, vary broadly, e.g. depending on their chemical constitution, kind of substrate and application conditions, and may range e.g. in the scope of 5 to 100%, preferably 10 to 80% by weight referred to the weight of (E)+(F), especially (E)+(F₂).

According to one feature of the invention at least a part of degreasing bath components (H) and/or (G), may be combined with (E) and (F) in (D′) as mentioned above for (S₂) and (S₄) respectively. Preferably, however, any or at least the major required proportion of surfactant (G) is added separately to the bath, as desired and as suitable in the concerned treatment stage and/or step. Solvent (H) may be added separately to the bath. According to a particular feature of the invention at least a part of (H) may be present as (S₂) in (D′) and any further (H) may be added directly to the bath. Preferably the degreasing compositions (D′) consist only of alkoxylates (E) and (F) or of alkoxylates (E) and (F) and one or more formulation additives (S) as described above.

For degreasing it is of advantage to use for the setting of the degreasing bath and also for rinsing an aqueous sodium chloride solution, e.g. of a concentration in the scope from 3 to 15%, preferably 5 to 10% by weight, referred to the weight of the aqueous solution.

Where degreasing is carried out on a pickled substrate, a polyphosphate, e.g. sodium polyphosphate, may be added before introducing (E) and (F) or the degreasing composition (D′) into the degreasing bath, e.g. in a concentration in the range of 0.5 to 5% by weight referred to the wet weight of the substrate. Main degreasing of a pickled substrate may advantageously be concluded by addition of a reducing agent, typically sodium thiosulphate, and by raising the pH from the conventional pickle values, e.g. in the range of 1.5-3.0, to values above 3.0, e.g. in the range of 3.5 to 5.0 or even 3.5 to 6.0, by addition of conventional bases or buffer salts such as sodium acetate. The sodium chloride concentration in the degreasing bath referred to the pickled substrate preferably is in the range of 7 to 15% by weight.

The degreasing treatment of the invention, with (E) and (F) or in particular with (D′) as mentioned above, may be carried out for a duration as conventional per se for degreasing, e.g. in the range of 1 to 4 hours, preferably 1.5 hours to 3 hours for every treatment stage (in one or two steps).

After completion of the degreasing treatment, which preferably is followed by rinsing or washing, the substrate may be directly further processed in the foreseen sequence of treatments for the production of the leather or pelt as desired. If desired, the degreased substrate may even be washed, drained and dried, for being e.g. stored or shipped in order to be further treated at a later stage. This may in particular be done where degreasing is carried out after pickling in the pickle bath. Preferably, however, the treatment sequence is not interrupted after degreasing, but the degreased substrate is further treated in the same apparatus. The substrate degreased according to the invention is readily and optimally suitable for each of the subsequent treatments.

By the process of the invention there may be achieved a thorough and careful degreasing of the substrate by extraction and emulsification of natural own grease present in the hide or even of fat that may have been added by e.g. fat-liquoring after (pre)tannage, and there may be achieved degreasing yields comparable to those obtainable with the corresponding ethoxylated nonylphenol. In particular even with substrates of extremely high grease content, such as sheepskins and pigskins, there may be achieved a surprisingly high degreasing even in the grain, without impairing other characteristic properties of the substrate, such as quality of the leather structure (especially the grain structure), handle, dyeability, pliability, porosity, light fastness, while a subsequent treatment with any chemicals finds in the substrate degreased according to the invention a substrate of high suitability for even distribution of the applied products, e.g. neutralising agents, filling/masking agents, (re)tanning agents, dyestuffs, leather softeners, products for improving water repellence etc., so that dyed and/or finished leathers and pelts of optimum quality are obtainable with a high yield of the corresponding applied products. According to the invention, where desired, a pre-determined partial degreasing may be carried out, to achieve a very regularly partially degreased substrate. Compositions (D′) of the invention further are distinguished by their synergism in degreasing, in particular on pickled skins.

In the following Examples parts and percentages are by weight and in the Application Examples the percentages refer to the wet weight of the substrate, if not otherwise indicated. The starting materials employed in Examples 1-5 and the additives employed in the Application Examples further to the degreasing agent, are commercially available products. The fatty acid methyl tauride sodium salt is CAS No. 137-20-2; the low chain alkylbenzene sulphonate sodium salt is CAS-No. 657-84-1 and the sodium polyphosphate is CAS-No. 68915-31-1. The “water of 7°Bé” in the Application Examples is an aqueous sodium chloride solution of a density corresponding to a hydrometer reading of 7 degrees Baumé, which corresponds to a sodium chloride concentration of 7% by weight referred to the weight of the solution. I.U.C. standards mentioned in the Application Examples are international standards in leather testing as recommended in IULTCS (International Union of Leather Technologists and Chemists Societies).

### EXAMPLE 1

### Production of an Ethoxylated Oxo-Alcohol (E₁₀₁)

In an autoclave 450 g of oxo-alcohol (A₁₀₁) are charged together with 9 g of an aqueous 50% potassium hydroxide solution and heated to 180° C. At this temperature the air and moisture present in the gaseous phase are displaced with nitrogen and then ethylene oxide is introduced and reacted in a proportion of 8 moles per mole of oxo-alcohol, maintaining the temperature at 200° C. When ethoxylation is complete the reaction mixture is allowed to cool and the ethoxylated oxo-alcohol (E₁₀₁) is discharged.

The oxo-alcohol (A₁₀₁) is an oxo-alcohol of the type (A₁₀) in which (A₁₀ₐ) is 50% of the mixture and (A_{10b}) to (A₁₀ₑ) are the remaining 50% in statistical distribution.

### EXAMPLE 2

### Production of an Ethoxylated Oxo-Alcohol (E₁₀₂)

The procedure described in Example 1 is repeated, with the difference that in place of oxo-alcohol (A₁₀₁) there is employed the same quantity of oxo-alcohol (A₁₀₂), which is a mixture of 42 parts of oxo-alcohol of the type (A₁₁) and 56 parts of oxo-alcohol of the type (A₁₂), where the proportion of primary linear components (A₁₁ₐ) and (A₁₂ₐ) is 46% and (A_{11b}) to (A_{11f}) and (A_{12b}) to (A_{12f}) are the remaining 54% in statistical distribution.

### EXAMPLE 3

### Production of an Ethoxylated Oxo-Alcohol (E₁₀₃)

The procedure described in Example 1 is repeated, with the difference that in place of oxo-alcohol (A₁₀₁) there is employed the same quantity of oxo-alcohol (A₁₀₃), which is a mixture of 20 parts of oxo-alcohol of the type (A₁₁), 31 parts of oxo-alcohol of the type (A₁₂), 29 parts of oxo-alcohol of the type (A₁₃), and 19 parts of oxo-alcohol of the type (A₁₄), where the proportion of primary linear components (A₁₁ₐ), (A₁₂ₐ), (A₁₃ₐ) and (A₁₄ₐ) is 43% and (A_{11b}) to (A_{11f}), (A_{12b}) to (A_{12f}), (A_{13b}) to (A_{13g}) and (A_{14b}) to (A_{14g}) are the remaining 57% in statistical distribution.

### EXAMPLE 4

### Production of an Ethoxylated Oxo-Alcohol (E₁₀₄)

The procedure described in Example 1 is repeated, with the difference that in place of oxo-alcohol (A₁₀₁) there is employed the same quantity of oxo-alcohol (A₁₀₄), which is a mixture of 62 parts of oxo-alcohol of the type (A₁₃) and 36 parts of oxo-alcohol of the type (A₁₄), where the proportion of primary linear components (A₁₃ₐ) and (A₁₄ₐ) is 40% and (A_{13b}) to (A_{13d}) and (A_{14b}) to (A_{14d}) are the remaining 60% in statistical distribution.

### EXAMPLE 5

### Production of an Ethoxylated Oxo-Alcohol (E₁₀₅)

The procedure described in Example 1 is repeated, with the difference that instead of 8 moles of ethylene oxide, 7 moles of ethylene oxide are reacted per mole of oxo-alcohol (A₁₀₁).

### EXAMPLE 6

### Production of an Ethoxylated Oxo-Alcohol (E₁₀₆)

The procedure described in Example 3 is repeated, with the difference that instead of 8 moles of ethylene oxide, 7 moles of ethylene oxide are reacted per mole of oxo-alcohol (A₁₀₃).

### EXAMPLE 7

### Production of an Ethoxylated Oxo-Alcohol (F₁₀₁)

The procedure described in Example 1 is repeated, with the difference that in place of oxo-alcohol (A₁₀₁) there is employed the same quantity of oxo-alcohol (B₁₀₁), which is an isotridecyl alcohol from hydroformylation/reduction of tributylene, and ethoxylation is carried out in a proportion of 7 moles of ethylene oxide per mole of isotridecyl alcohol.

### EXAMPLE 8

### Production of an Ethoxylated Oxo-Alcohol (F₁₀₂)

The procedure described in Example 7 is repeated, with the difference that in place of oxo-alcohol (B₁₀₁) there is employed the same quantity of oxo-alcohol (B₁₀₂), which is an isotridecyl alcohol according to CAS Nr. 68526-86-3 with an average degree of branching of 2.9, and ethoxylation is carried out in a proportion of 8 moles of ethylene oxide per mole of isotridecyl alcohol.

Degreasing Composition (D₁₀₁)

60 parts of (E₁₀₁) are mixed at ambient temperature (=20° C.) with 35 parts of (F₁₀₁) and 5 parts of water.

Degreasing Composition (D₁₀₂)

60 parts of (E₁₀₂) are mixed at ambient temperature with 35 parts of (F₁₀₁) and 5 parts of water.

Degreasing Composition (D₁₀₃)

60 parts of (E₁₀₃) are mixed at ambient temperature with 35 parts of (F₁₀₁) and 5 parts of water.

Degreasing Composition (D₁₀₄)

60 parts of (E₁₀₄) are mixed at ambient temperature with 35 parts of (F₁₀₁) and 5 parts of water.

Degreasing Composition (D₁₀₅)

53.8 parts of (E₁₀₃) are mixed at ambient temperature with 29.4 parts of (F₁₀₁), 4.9 parts of hexylene glycol and 11.9 parts of water.

Degreasing Composition (D₁₀₆)

40 parts of (E₁₀₅) are mixed at ambient temperature with 39 parts of (F₁₀₂), 11 parts of (E₁₀₆), 1 part of lauryl-(2)-ethylene glycolether sulphate sodium salt and 15 parts of water.

### APPLICATION EXAMPLE A

### Degreasing of Pickled Sheepskins (Percentages are Based on the Pickled Weight)

Pickled GB domestic sheepskins samples (according to I.U.C. standard 2) are given into a drum and 150% of water of 7°Bé at 20° C. are added, followed by 2% of sodium polyphosphate and 2% sodium (C₁₋₃-alkyl)benzene sulphonate and the drum is rotated for 1 hour. The pH is 2.1. Then 3% of degreasing agent (D₁₀₃) and 1% of diethylene glycol monobutyl ether are added and drumming is continued for 120 minutes at the same temperature. 1% of sodium thiosulphate is added and drumming is carried on for 30 minutes until the pH is 2.2, then sodium acetate is added in three additions of 1% each at intervals of 15 minutes and after the third addition drumming is carried on for 30 minutes. The pH is 4.5. The bath is drained, 200% of water of 7°Bé at 25° C. is added and the goods are washed for 45 minutes, then the bath is drained. 100% of water of 7°Bé at 25° C., 3% of degreasing agent (D₁₀₃) and 0.5% of fatty acid methyl tauride sodium salt are added and the drum is rotated for 60 minutes at this temperature. The bath is drained and the goods are washed three times for 15 minutes with water at 25° C. and then the bath is drained and the degreased sheepskins are discharged and dried for assessing the residual grease content. The samples are degreased very regularly and to a high degree and are optimally suitable for further processing in the tannery.

If in the above Application Example A, instead of the degreasing agent (D₁₀₃) there is employed the same concentration of each of degreasing agents (D₁₀₁), (D₁₀₂), (D₁₀₄) (D₁₀₅) or (D₁₀₆) there is also achieved a substantial grease content reduction.

### APPLICATION EXAMPLE B

### Degreasing of Pickled Sheepskins (Percentages are Based on the Pickled Weight)

Pickled GB domestic sheepskins samples (according to I.U.C. standard 2) are given into a drum and 150% of water of 7°Bé at 20° C. are added, followed by 2% of sodium polyphosphate and 2% sodium (C₁₋₃-alkyl)benzene sulphonate and the drum is rotated for 1 hour. The pH is 2.1. Then 3% of degreasing agent (D₁₀₅) and 1% of diethylene glycol monobutyl ether are added and drumming is continued for 120 minutes at the same temperature. 1% of sodium thiosulphate is added and drumming is carried on for 30 minutes, then sodium acetate is added in three additions of 1% each at intervals of 15 minutes and after the third addition drumming is carried on for 30 minutes. The pH is 4.5. The bath is drained, 200% of water of 7°Bé at 25° C. is added and the goods are washed for 45 minutes, then the bath is drained. 100% of water of 7°Bé at 25° C., 3% of degreasing agent (D₁₀₅) and 0.5% of fatty acid methyl tauride sodium salt are added and the drum is rotated for 60 minutes at this temperature. The bath is drained and the goods are washed three times for 15 minutes with water at 25° C. and then the bath is drained and the degreased sheepskins are discharged and dried for assessing the residual grease content. The samples are degreased very regularly and to a high degree and are optimally suitable for further processing in the tannery.

Using in Application Example B a pickled sheepskin with an extractable grease content of 19.5% (average of three samples according to I.U.C. standard 2 and three tests) the degreased skin had a residual extractable grease content of 11.4% (average of three samples according to I.U.C. standard 2 and three tests), whereas repeating the same procedure with the difference that the components of composition (D₁₀₅) were added separately and sequentially at an interval of 30′, the degreased skin had an extractable grease content of 12.1% (average of three samples according to I.U.C. standard 2 and three tests).

If in the above Application Example B, instead of the degreasing agent (D₁₀₅) there is employed the same concentration of each of degreasing agents (D₁₀₁), (D₁₀₂), (D₁₀₃) (D₁₀₄) or (D₁₀₆) there is also achieved a substantial grease content reduction.

1. A process for wet degreasing a pelt, skin, hide, leather intermediate product or non-finished leather comprising the steps of providing a pelt, skin, hide, leather intermediate product or non-finished leather, and applying an emulsion degreasing agent (D) in the presence of water, wherein the emulsion degreasing agent (D) comprises
a mixture (E) of ethoxylation products or ethoxylation and propoxylation products of oxo-alcohols (A) of formula (I),
CₙH₍₂ₙ₊₁₎—CH₂OH (I),
wherein
n is a number from 9 to 15
and the alkyl radical CₙH₍₂ₙ₊₁₎— is linear,
wherein (A) comprises a mixture of positional isomers for at least one of the values of n, and the proportion of primary linear component in (A) wherein the alkyl radical CₙH₍₂ₙ₊₁₎— is a normal primary radical in the range of 25 to 70% by weight of the mixture (A),
wherein within the mixture (E) the average degree of ethoxylation is in the range of 5 to 12, and if the products within the mixture (E) are also propoxylated the average degree of ethoxylation is greater than the average degree of propoxylation,
and at least one further non-ionic emulsifier (F) wherein
(F) is at least one ethoxylation product or ethoxylation and propoxylation product of (B) wherein (B) is an at least twice branched aliphatic saturated alcohol, or a mixture thereof.

2. (canceled)

3. A process according to claim 1, wherein (E) is of the formula (II) 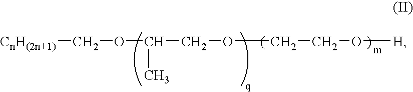
wherein
m is a number from 5 to 12,
n is a number from 9 to 15
and q<m.

4. A process according to claim 1, wherein (F) is
(F₀) at least one ethoxylation product or ethoxylation and propoxylation product of
(B₀) one or more at least twice branched primary aliphatic saturated alcohols.

5. A process according to claim 1, wherein (F) is
(F₁) at least one ethoxylation product or ethoxylation and propoxylation product of
(B₁) one or more at least twice branched oxo-alcohols.

6. A process according to claim 1, wherein (F) is
(F₂) an ethoxylation product or ethoxylation and propoxylation product of
(B₂) one or more oxo-alcohols of the formula
CₚH₍₂ₚ₊₁₎—CH₂OH (III),
wherein
p is a number from 9 to 16,
and the alkyl radical CₚH₍₂ₚ₊₁₎— is branched at at least two different carbon atoms,
and the average degree of ethoxylation is in the range of 5 to 12, and if the product (F₂) is also propoxylated the average degree of ethoxylation is greater than the average degree of propoxylation.

7. A process according to claim 6, wherein (F₂) is of the formula (IV), 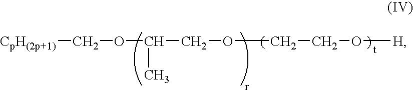
wherein
p is a number from 9 to 16
t is a number from 5 to 12
and r<t.

8. A process according to claim 1, wherein the calculated HLB of (E) is in the range of 11 to 15.

9. A process according to claim 1, wherein the calculated HLB of (F) is in the range of 11 to 15.

10. A process according to claim 1, wherein the weight ratio of (E) to (F) is in the range of 100/5 to 100/100.

11. A process according to claim 1, wherein the applying step is carried out in the presence of one or more anionic surfactants (G) and/or a water miscible solvents (H).

12. A process for the production of leather, pelts or furskins, comprising the steps of a degreasing treatment, a tannage and a dyeing or finishing treatment, wherein the degreasing treatment is carried out according claim 1.

13. A degreasing agent (D′) comprising a mixture (E) of ethoxylation products or ethoxylation and propoxylation products of oxo-alcohols (A) of formula (I),
CₙH₍₂ₙ₊₁₎—CH₂OH (I),
wherein
n is a number from 9 to 15
and the alkyl radical CₙH₍₂ₙ₊₁₎— is linear,
wherein (A) comprises a mixture of positional isomers for at least one of the values of n, and the proportion of primary linear component in (A) wherein the alkyl radical CₙH₂ₙ₊₁₎— is a normal primary radical in the range of 25 to 70% by weight of the mixture (A),
wherein within the mixture (E) the average degree of ethoxylation is in the range of 5 to 12, and if the products within the mixture (E) are also propoxylated the average degree of ethoxylation is greater than the average degree of propoxylation,
and at least one further non-ionic emulsifier (F)
wherein
(F) is at least one ethoxylation product or ethoxylation and propoxylation product of (B) wherein (B) is an at least twice branched aliphatic saturated alcohol, or a mixture thereof.

14. A decreasing agent (D′) according to claim 13, further comprising at least one formulation additive (S) selected from the group consisting of:
(S₁) water,
(S₂) an organic solvent or mixture and/or solubiliser or mixture miscible with or soluble in (E) and (F) or in which (E) and (F) are soluble,
(S₃) a defoamer
and (S₄) at least one anionic surfactant.

15. A degreasing agent (D′) according to claim 14, wherein (S) is selected from the group consisting of: (S₁), (S₂) and a mixture of (S₁) and (S₂).

16. A degreasing agent (D′) according to claim 14, wherein formulation additive (S) selected from the group consisting of: (S₄) and a mixture of (S₄) and (S₁).

17. A degreasing agent (D′) according to claim 14, with an (S₁)-content<50%.

18. A process for the production of a degreasing agent (D′) according to claim 13, comprising the step of mixing component (E) with component (F) and optionally any formulation additive (S).

19. A wet degreasing process according to claim 1 wherein (E) and (F) are employed in the form of a composition.

20. A process for the production of a degreasing agent (D′) according to claim 13, comprising the steps of alkoxylating a mixture of (A) and (B) with the required amount of ethylene oxide and optionally any propylene oxide, and optionally adding any formulation additive (S).

21. A pelt, skin, hide, leather intermediate product or non-finished leather degreased according to the process of claim 1.
